(19) United States
(12) Patent Application Publication
(10) Pub. No.: US 2026/0155766 A1
(43) Pub. Date: Jun. 4, 2026

(54) SYSTEMS AND METHODS FOR SENSORLESS CONTROL OF A MOTOR

(71) Applicant: Mitsubishi Electric Research Laboratories, Inc., Cambridge, MA (US)

(72) Inventors: Yebin Wang, Cambridge, MA (US); Jingjie Wu, Madison, WI (US)

(73) Assignee: Mitsubishi Electric Research Laboratories, Inc., Cambridge, MA (US)

(21) Appl. No.: 19/013,258

(22) Filed: Jan. 8, 2025

Related U.S. Application Data
(60) Provisional application No. 63/726,418, filed on Nov. 29, 2024.

(51) Int. Cl. H02P 21/26; H02P 21/00; H02P 21/14; H02P 21/18

(52) U.S. Cl. CPC H02P 21/26; H02P 21/0003; H02P 21/141; H02P 21/18; H02P 2207/01

(57) ABSTRACT

A system and method for controlling the operation of an induction motor under varying condition are disclosed. A signal injection module generates a high-frequency signal at a dynamically adjustable tilted angle relative to the rotor flux reference frame. A current measurement module monitors real-time d-axis and q-axis currents during motor operation. A tilted angle module determines the tilted angle to maximize the slope gain of a torque control error signal while maintaining stability by ensuring a consistent sign of the gain. An offset correction module applies corrections to the torque control error signal, compensating for inaccuracies caused by high-frequency signal injection. The tilted angle is dynamically adjusted in response to operational conditions to ensure stable motor operation. This system provides precises torque control and stable performance across varying conditions, including near-zero frequency.

### TECHNICAL FIELD

The present disclosure relates generally to control systems for electric motors and more particularly to systems and methods for controlling the speed and/or torque of electric motors without using sensors for measuring the speed or the position of the motor.

### BACKGROUND

Induction motors with variable speed and torque are widely used due to their low maintenance costs and reliable performance. However, controlling these motors poses challenges because of their inherent nonlinear dynamics. Vector control, also known as field-oriented control (FOC), is a common approach for managing induction motors. In FOC, the stator currents of a three phase AC electric motor are represented as two orthogonal components, allowing one component to align with the rotor magnetic flux while the other influences the electromagnetic torque. The control system of the drive utilizes a high-level controller to calculate the corresponding current component references given the flux and speed or torque references and measurement. For example, proportional-integral (PI) controllers can be used to keep the measured current components at their reference values.

Sensorless control methods eliminate the need for physical speed sensors, which reduces costs and enhances system reliability. These motor drive systems and motors are sensorless in that they do not include functionality to measure the voltage feedback from the motor and/or sensors to detect the position of the motor rotor. Rather, rotor position is determined based on estimates of the motor winding currents. Sensorless control of induction motor eliminates the need for physical speed or position sensors, reducing costs and improving system reliability. Speed sensorless motor drive is desirable due to the elimination of motor speed or position sensors, the lower cost, and the improved reliability of the resultant system. One aspect of sensorless control includes determining rotor speed without direct measurement. This can be achieved through two primary approaches, fundamental model-based approach and signal injection-based approach.

The fundamental model-based approach (also referred to as the baseline method) uses a dynamics model of the rotor to estimate rotor speed from current measurements. Such model-based approaches characterize the dynamic response of the motor supplied by voltages in fundamental frequency. The fundamental dynamic model of the motor is used in the design of the state/speed estimator Examples of such model-based approaches include voltage model-based integration, adaptive observers, and extended Kalman filters. However, these approaches fail at/near zero/low frequency or zero/low speed. This is because the fundamental model of the motor fails to characterize the relationship between speed and measured current signal. As such, it is very difficult, if not impossible, to estimate the speed based on the fundamental model and the measurement of current signal in such operating conditions.

To address these limitations, high frequency injection-based (HFI) methods exploit motor saliency to improve observability at low speed or near-zero frequencies. High-frequency signals are injected into the motor, and the resulting current response is analyzed to estimate rotor speed or position. Among HFI methods, the pulsating signal injection in the estimated d-q reference frame is effective due to its superior current regulation and estimation bandwidth. However, challenges such as saliency orientation shift (SOS) under loaded operations cause shifting of the position of saliency away from the actual rotor flux position which can introduce flux angle estimation errors. Although some compensation techniques partially mitigate these errors, they lack systematic analysis and experimental validation to exploit and identify the operational limit for a specific induction machine under square-wave HFI. As such, the SOS compensation method still requires improvement. As a result, the sensorless torque capability is limited at low/zero frequency.

Although HFI is advantageous at low speeds, it becomes less desirable at medium to high speeds due to reduced voltage availability for motor operation. At these higher speeds, fundamental model-based methods are preferred. Available solutions lack an effective mechanism to integrate HFI and fundamental model-based methods, making it difficult to achieve seamless operation across the entire speed range.

### SUMMARY

Accordingly, there is a need for systems and methods that integrate HFI and fundamental model-based methods, enabling smooth transitions between control modes and ensuring robust sensorless performance across a wide range of operating conditions.

It is an objective of some embodiments of the present disclosure to provide robust control of an induction machine across a wide range of operational speeds, including near-zero frequency operation. Some embodiments are directed towards providing a method and a system for controlling the output torque of an induction motor over a wide range of operation region including near/at zero frequency.

Some embodiments are based on the recognition that HFI methods face limitations due to torque control instability caused by saliency shifts under load, while fundamental model-based approaches are ineffective at near-zero frequencies. In particular, some embodiments realize that HFI methods fail to achieve effective torque regulation because the high frequency leakage inductance saliency changes according to both q-axis torque current and d-axis flux current. The angle of shift of the leakage inductance saliency (SOS) is the angle that the injected signal is applied with respect to the d-axis in the rotor flux reference frame and the corresponding error signal into the phase locked loop (PLL) obtained from the SOS-tilted q-axis current response is zero. It is a further realization of some embodiments that the stable torque control entails from the fact that the slope gain of the error signal with respect to the rotor flux angle error (i.e., the error between the estimated rotor flux angle and the rotor flux true angle) should not change sign over the entire operation conditions to ensure the convergence. It is a further realization of some embodiments that the larger the slope gain is, the better it is for stable torque control in terms of signal-to-noise ratio (SNR) and robustness against model uncertainties. It is a further realization of some embodiments that both the sign and amplitude of the slope gain are dependent on the angle that the injected high frequency signal is applied, the amplitude of the q-axis current, and the amplitude of the d-axis current.

Some embodiments are also based on the realization that setting the tilted injection angle to the SOS is not always useful because under different operation conditions (characterized by d-axis current and q-axis current), the corresponding slope gain may change sign, causing instability in torque control. Some embodiments are based on another realization that it is advantageous to inject the signal along the angle (called tilted angle) which yields the max slope gain while keeping the sign of the gain the same, wherein the tilted angle is determined on the knowledge of d-axis current and the q-axis current. Since the tilted angle does not equal the SOS, the current response error signal into the PLL induced by the high-frequency voltage signal injected along the tilted angle may not be zero even if the error between the estimated rotor flux angle and the true rotor flux angle is zero. Hence cancellation of the offset is off essence, where the offset is also dependent on the tilted angle, the amplitude of the q-axis current, and the amplitude of the d-axis current.

To address these challenges, various embodiments introduce a tilted injection angle dynamically determined to maximize the slope gain of the torque control error signal. This tilted injection angle ensures stable torque control by maintaining a consistent slope gain sign across varying operational conditions. Additionally, some embodiments incorporate an offset correction mechanism to compensate for error signal offset caused by discrepancies between the tilted angle and the saliency orientation shift (SOS). The offset correction is dynamically calibrated based on the q-axis and d-axis current amplitudes. Some embodiments provide solutions tailored for calibrating the tilted angle as a function of the amplitude of the q-axis current, and the amplitude of the d-axis current, and the offset as a function of the tilted angle. In some embodiments, the d-axis current is fixed when high frequency injection method is in effect (near/at zero frequency operation). Some embodiments are also directed towards calibrating the tilted angle and the offset as two separate functions of the amplitude of the q-axis current.

Further, some embodiments fix the d-axis current during HFI operation to improve control precision under near-zero frequency conditions, the tilted angle and offset are separately calibrated as functions of the q-axis current amplitude, ensuring precise torque regulation. To enhance dynamic performance, a scaling method is applied to the torque control error signal offset correction, with the scaling parameter determined by the sloped gain associated with the q-axis current amplitude. This approach ensures consistent performance and maintain constant PLL poles across operational conditions. Accordingly, some embodiments provide a method to scale the error signal after subtracting the offset to maintain constant PLL poles and achieve decent and consistent dynamic performance in all operation conditions. The scaling parameter is calibrated as a function of the amplitude of the q-axis current using the corresponding slope gain.

Moreover, some embodiments provide a seamless transition between HFI based control for near-zero frequencies and fundamental model-based control for higher speeds. This is achieved using a switching mechanism that monitors the rotor speed derivative, enabling smooth transition and maintaining stable control across full operational range of the motor. Accordingly, some embodiments are directed towards a method for switching between high frequency injection-based method and the fundamental model-based method to achieve whole speed and torque operation, wherein the former operates at near/zero frequency operation region and the latter operates at the rest of operation region. Particularly, the disclosed method switches the time derivative of the rotor speed estimator to ensure smooth transition.

Some embodiments provide systems and methods for producing an error signal for the smooth switch between high frequency injection-based method and the fundamental model-based method. In this regard, it is a realization of various embodiments that the HFI-based method detects the frequency directly as:

$${ω}_{r} = ( {K}_{p} + \frac{{K}_{I}}{s} ) ( ϵ - {ϵ}_{0} )$$

where ϵ is the output of the PLL, ϵ₀ is the offset,

$${K}_{p} = 2 {ξω}_{bw} , {K}_{i} = {ω}_{bw}^{2} , ξ ∈ ( 0 , 1 ]$$

is the damping ratio and ω_{bw} is the closed loop bandwidth.

The fundamental model-based method estimates the rotor speed as

$${\hat{ω}}_{r} = {\int }_{0}^{t} ( {K}_{p} + \frac{{K}_{I}}{s} ) {e}_{i q} dt ,$$

where e_{iq} is the error between the estimated q-axis current and the measured q-axis current with the estimated q-axis current being produced by the flux observer of the fundamental model-based approach.

Some embodiments realize that conventional switching mechanism introduce a 90 degrees phase lag in the HFI-based method and therefore does not work well for full operational speed ranges of the induction motor. To overcome such drawbacks, some embodiments provide a switching method between the HFI-based method and the fundamental model-based method as:

$${\dot{\hat{ω}}}_{r} = \{ \begin{matrix}( {K}_{p} + \frac{{K}_{i}}{s} ) LP ( ϵ - {ϵ}_{0} ) , & low or near zero frequency operation \\ ( {K}_{p} + \frac{{K}_{I}}{s} ) {e}_{i q} , & otherwise\end{matrix}$$

where LP(·) is a lead compensator.

In order to achieve the aforementioned objectives and advantages, some embodiments provide systems, methods, and apparatuses for controlling an operation of an induction motor across varying operational conditions, including near-zero frequency.

According to one embodiment, a method for controlling an operation of an induction motor across varying operational conditions including near-zero frequency is provided. The method comprises collecting a reference value of d-axis current of the induction motor, a reference value of q-axis current of the induction motor, and a torque control error signal for the induction motor. The method further comprises operating the induction motor in accordance with the reference value of d-axis current and the reference value of q-axis current and measuring real-time amplitudes of the d-axis current and the q-axis current in an estimated rotor flux reference frame during the operation of the induction motor. An estimated rotor flux reference frame angle represents the position of the estimated rotor flux frame. The method further comprises calculating a tilted angle relative to the estimated rotor flux reference frame for the induction motor, based on the real-time amplitudes of d-axis current and q-axis current. The tilted angle is determined offline to maximize a slope gain from the error between the estimated rotor flux reference frame angle and a true rotor flux reference frame angle to the torque control error signal while maintaining a consistent sign of the slope gain across the varying operating conditions. The method further comprises injecting a high-frequency signal into the induction motor at the calculated tilted angle relative to the estimated rotor flux reference frame and applying an offset correction to the torque control error signal, based on the calculated tilted angle, the measured d-axis current amplitude, and the measured q-axis current amplitude to compensate for inaccuracies arising from the high-frequency signal injection. The method further comprises adjusting the tilted angle continuously in response to changing operational conditions.

In yet another embodiment, a system for controlling an induction motor across varying operational conditions including near-zero frequency is provided. The system comprises circuitry configured to inject a high frequency injection (HFI) signal into the induction motor at an adjustable tilted angle relative to an estimated rotor flux reference frame and measure real-time amplitude of d-axis current and real-time amplitude of q-axis current during the operation of the induction motor. The circuitry is further configured to dynamically determine the tilted angle based on the real-time amplitude of d-axis current and real-time amplitude of q-axis current. The tilted angle is determined offline to maximize a slope gain from the error between the estimated rotor flux reference frame angle and a true rotor flux reference frame angle to a torque control error signal, while maintaining a consistent sign of the slop gain across varying operational conditions. The circuitry is further configured to apply an offset correction to the torque control error signal based on the calculated tilted angle, the measured real-time amplitudes of d-axis current and real-time amplitudes of q-axis current to compensate for inaccuracies from the HFI signal. The circuitry is further configured to continuously adjust the tilted angle in response to changing operational conditions of the induction motor.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A is a block diagram of a control system for sensorless control of a motor, according to some example embodiments;

FIG. 1B is a flowchart of a method for sensorless control of a motor, according to some example embodiments;

FIG. 2A is a block diagram of a motion control system, according to some example embodiments;

FIG. 2B is a block diagram of an inverter of the motion control system of FIG. 2A, according to some example embodiments;

FIG. 2C is a coordinate and vector diagram of an induction motor, according to an example embodiment;

FIG. 3A is a block diagram of a drive controller for operating an induction machine at torque control mode, according to an example embodiment;

FIG. 3B is a flowchart of method for commissioning the control method, according to an example embodiment;

FIG. 4 illustrates additional reference frames utilized in the HFI based detection method, according to an example embodiment;

FIG. 5 illustrates a signal generation module for generating the HFI signal, according to an example embodiment;

FIG. 6 illustrates an HFI-based detection module, according to an example embodiment;

FIG. 7A is a flowchart of a method to calibrate a first function of q-axis current reference, according to an example embodiment;

FIG. 7B is a flowchart of a method to determine the sensitivity of the system from the rotor flux angle error to a torque control error signal for an induction motor, according to an example embodiment;

FIG. 8 is a flowchart of a method to calibrate a second function and a third function of q-axis current reference, according to an example embodiment;

FIG. 9 is a flowchart of a method for performing a standstill experiment for operating an induction motor; and

FIG. 10 illustrates some components of a system for controlling a motor, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Several real-world applications of induction motors require sensorless control and operation of such motors. Speed sensorless control of the electric motors avoids measuring the speed of the motor. Such a control is referred to as a speed sensorless control implemented by a speed sensorless motor drive, i.e., control system that does not use a sensor to measure speed or position of the rotor of the motor. Speed sensorless motor drive is desirable due to the elimination of motor speed or position sensors, the lower cost, and the improved reliability of the resultant system.

A key aspect of the speed sensorless motor drive is to determine the rotor speed of the motor. Two such approaches for determining the rotor speed of the motor include the fundamental model-based approach and the signal injection-based approach. The fundamental model-based speed sensorless motor drive relies on a fundamental model of the motor to infer the rotor speed from measured current signal, where the fundamental model characterizes the dynamic response of the motor supplied by voltages in fundamental frequency. However, the fundamental model-based speed sensorless motor drive can fail to control the motor reliably when the motor is operated at/near zero/low frequency or zero/low speed. This is because the fundamental model of the motor fails to characterize the relationship between speed and measured current signal. Amongst the signal injection-based approaches, the high frequency injection-based (HFI) method exploits the anisotropic properties of the machine to enable the sensorless operation in zero/low frequency region without using a fundamental dynamic model. Specifically, the current response induced by high-frequency voltage injection is measured and used to track the magnetic spatial saliency and thus estimate the field or rotor position and then rotor speed.

High-frequency signal injection is typically used for controlling torque, but it fails under certain conditions due to changing inductance saliency influenced by d-axis and q-axis currents. This leads to instability in torque control. To stabilize torque, a specific angle (SOS) for signal injection is needed. However, under different operating conditions, the optimal angle changes, leading to potential instability if not adjusted.

In the context of electric motors, saliency refers to the variation in magnetic properties within the motor, specifically the differences in inductance along different axes of the rotor. These variations occur because the magnetic flux encounters different levels of resistance depending on the orientation, which influences the motor's inductance characteristics. For induction motors, a reference coordinate frame called as dq frame defined by a direct axis (d-axis) and a quadrature axis (q-axis) is generally utilized. When the magnetic pole direction of a rotor is set as a d-axis and an axis electrically and magnetically orthogonal to the d-axis is set as a q-axis in a dq coordinate control system, d-axis current represents an excitation current component that is used to generate magnetic flux, and q-axis current represents an armature current component corresponding to load torque.

Saliency arises because the inductance along these axes can differ due to the motor's construction and magnetic properties. This difference means that the response to an injected high-frequency (HF) signal can vary depending on the alignment with these axes. For advanced control strategies, such as those using high-frequency signal injection (e.g., for torque or position estimation), saliency provides a way to measure and regulate the motor's performance. For example, by injecting a high-frequency signal and observing the motor's response, the system can estimate parameters like rotor position and torque. Furthermore, changes in inductance along the q-axis and d-axis allow the controller to detect the rotor's position or the flux vector orientation, enabling precise torque control. In essence, saliency is a property leveraged to enhance control accuracy by using the differences in magnetic properties to provide feedback or regulate motor performance.

Saliency orientation shift (SOS) angle is a specific angle at which the high-frequency signal is injected relative to the rotor's magnetic flux, specifically aligned with the d-axis of the rotor's flux. Injecting the HF signal at the SOS angle helps identify motor parameters and control torque, which however is not directly related to the stability of resultant closed-loop control system. Thus, it works well only under certain conditions. When operating conditions change (such as shifts in d-axis or q-axis current), the SOS angle does not adapt, which can lead to instability or inaccuracies in torque control.

The tilted angle is a dynamically adjusted angle for HF signal injection that responds to real-time conditions, specifically the current amplitudes in both the d-axis and q-axis. Instead of staying fixed like the SOS angle, the tilted angle varies with the motor's operating state to maximize the “slope gain” (the responsiveness of the torque control error signal or simply error signal) as well as ensure the sign of the slope gain-critical for the closed-loop control system stability. This adjustment ensures that the motor maintains stable torque control even as the conditions vary. By adapting the injection angle in real-time, the tilted angle helps avoid situations where the gain changes sign, which can lead to instability. The tilted angle optimizes the error signal's responsiveness, improving signal-to-noise ratio and allowing more precise control. Since the tilted angle is not aligned to the SOS, some error can enter the system. The method includes an offset correction based on the tilted angle to further fine-tune the control.

Therefore, using a tilted angle for HF injection provides a more flexible and robust approach to maintaining torque control, especially under varied operating conditions, as opposed to relying on a static SOS angle which cannot adapt to changes in d-axis and q-axis current amplitudes.

### Motor Control System and Method

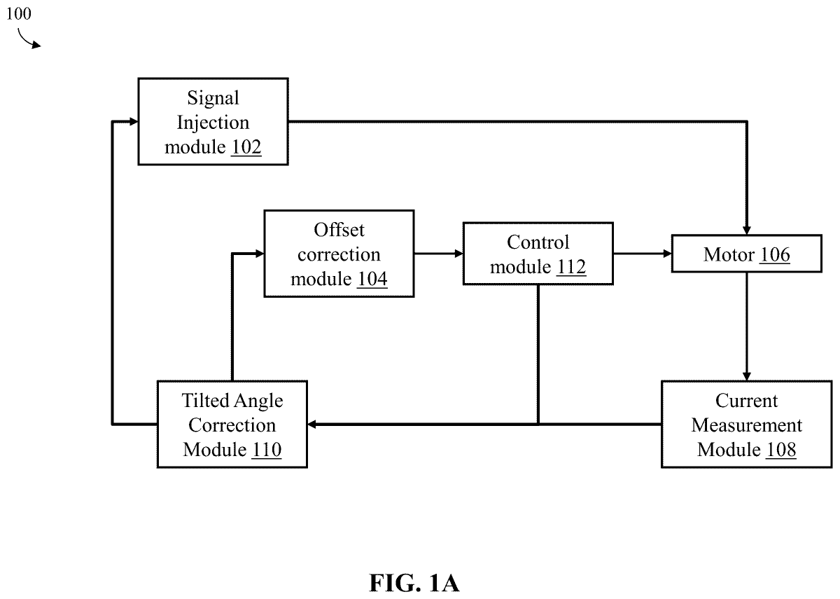

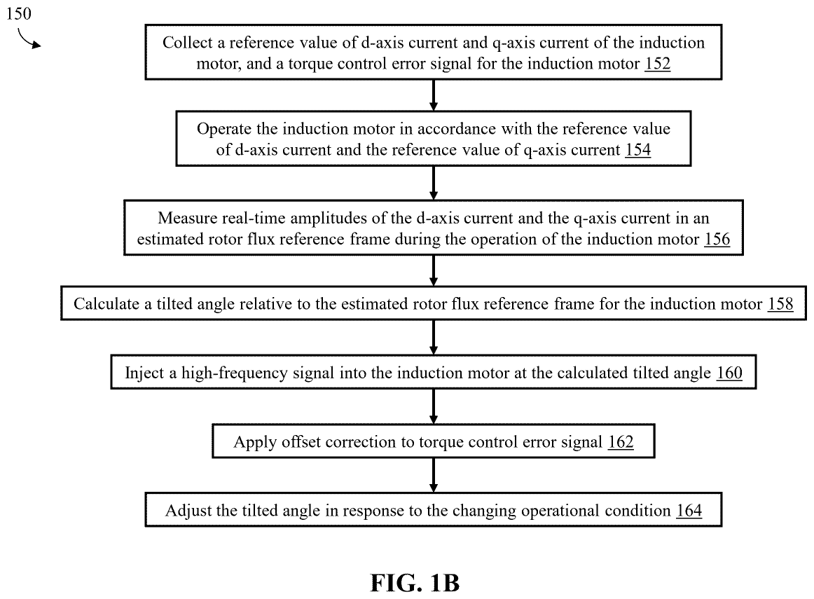

FIG. 1A is a block diagram of motor control system 100 is shown, according to some embodiments. In various embodiments the motor control system performs controlling an induction motor across varying operational condition, including near-zero frequency operation. The system comprises several interconnected components that work together to ensure precise torque control and motor stability.

The signal injection module 102 generates and injects an injection signal such as a high-frequency injection signal (HFI) into the motor 106 at a specific tilted angle. This signal improves the motor control, especially during the low or near zero frequency operation, by exciting the system and enabling the detection of key parameters like rotor flux angle. The tilted angle at which the HFI signal has to be injected is provided by the tilted angle correction module 110. The signal injection module 102 injects the HFI signal according to the tilted angle received from the tilted angle module 110, ensuring optional signal injection for accurate torque estimation.

Offset correction module 104 compensates for inaccuracies in the torque control error signal caused by the HFI signal. It ensures that any offset in the torque error signal is nullified to maintain accurate motor operation. The requirement for offset adjustment emerges due to even a slight error in the tilted angle. There may be error in estimating the tilted angle which leads to offset that is detected and corrected by the offset correction module 104. Based on the real time data provided by the current measurement module 108, the q-axis and d-axis current is compared with the reference and then it is corrected by the offset correction module 104. The corrected torque control signal is then sent to the control module 112 for controlling the motor 106. Based on the real time current measurement and tilted angle, the offset correction module 104 computes and applies an offset correction to the torque control signal, ensuring precise control despite disturbances introduced by the HFI signal.

The control module 112 adjusts the motor operation dynamically based on the corrected signals from the offset correction module 104. The control module 112 also receives the computed tilted angle. It processes these inputs to adjust motor control parameters, including the injected signal and rotor flux estimation.

The motor 106 is the primary actuator, generating torque based on the corrected control signal and responding to the HFI signal injected by the signal injection module. The torque generated by the motor 106 is corrected and controlled by the control signal from the control module 112. During the operation, the motor 106 generates torque while simultaneously providing feedback in the form of current measurement to other modules in the system.

The current measurement module 108 implicitly measures the real time d-axis and q-axis current amplitudes generated by the motor 106 during operation, by applying Clarke and Park transformations on measured currents of phases A, B, and C. The input to the current measurement module 108 is given by the feedback signal from the motor 106. The output, measured current data, is sent to the tilted angle module 110 and to the offset correction module 104 for correcting the tilted angle and for correcting the offset caused by the tilted angle. The current measurement module 108 ensures the real time availability of accurate current measurement, which are critical for the tilted angle calculation and error correction.

In some embodiments, the tilted angle correction module 110 receives the references of the d-axis and q-axis currents as input. In another embodiments, the tilted angle correction module 110 receives the references of the d-axis current and torque as input.

The tilted angle module calculates the optimal tilted angle for the HFI signal. This angle maximizes the slope gain of the torque control signal while maintaining stability. The tilted angle calculation is done using the real time q-axis and d-axis current measurement for them current measurement module 108. The calculated tilted angle information is sent to the signal injection module 102 and offset correction module 104. The tilted angle module dynamically adjusts the tilted angle based on the current operation condition of the motor 106, ensuring stable and efficient torque control.

The torque control error signal may be produced by a sequential approach comprising processing the q-axis current with a band pass filter to obtain a high frequency component which is then demodulated to determine the amplitude of a first error signal. The sequential approach further comprises applying the offset correction to obtain a second error signal by removing offset from the first error signal. The second error signal is then scaled to obtain a third error signal. The sequential approach further comprises processing the third error signal to produce an estimate of rotor flux angle, rotor flux frequency, and rotor speed of the induction motor. In this regard, the third error signal is fed through a lead compensator and phase locked loop is applied to the output of the lead compensator to produce an estimate of the rotor speed.

FIG. 1B is a flowchart of a method 150 for controlling an operation of an induction motor across varying operational conditions. The method 150 may be executed at least in part by the motor control system 100 of FIG. 1. Therefore, various embodiments described in reference to FIG. 1 may be read in conjunction with the description of FIG. 1B. The flowchart outlines the step-by-step methodology for achieving precise torque control of an induction motor under varying operational condition, including near zero frequency. The method 150 integrates real time measurement and adjustments to ensure stable motor operation. The steps are described in details below.

The method 150 comprises collecting 152 a reference value of d-axis current of the induction motor, a reference value of q-axis current of the induction motor, and a torque control error signal for the induction motor. The induction motor is operated 154 in accordance with the reference value of d-axis current and the reference value of q-axis current and the real-time amplitudes of the d-axis current and the q-axis current (in the estimated dq frame or equivalently the estimated rotor flux reference frame) during the operation of the induction motor are measured 156. The method further comprises calculating 158 a tilted angle relative to an estimated rotor flux reference frame for the induction motor, based on the real-time amplitudes of d-axis current and q-axis current (in the estimated rotor flux reference frame). The tilted angle is calculated to maximize a slope gain from the estimated rotor flux reference frame to the torque control error signal while maintaining a consistent sign of the slope gain across the varying operating conditions. The method further comprises injecting 160 a high-frequency signal into the induction motor at the calculated tilted angle relative to the estimated rotor flux reference frame. The signal injection also introduces discrepancies between the tilted angle and the saliency orientation shift (SOS) which requires offset correction. In this regard, the method 150 comprises applying 162 an offset correction to the torque control error signal, based on the calculated tilted angle, the measured d-axis current amplitude, and the measured q-axis current amplitude to compensate for inaccuracies arising from the high-frequency signal injection. The method further comprises adjusting 164 the tilted angle continuously in response to changing operational conditions.

The operational and modelling aspects of motor control are now described in detail. However, it may be contemplated the description is only exemplary and should not be considered as limiting for the disclosed embodiments.

Some notations used in this disclosure are given in Table 1. Given dummy variable ξ, \hat{ξ} represents its estimate, and \tilde{ξ} denotes the error between the true value and the estimated value, i.e., \tilde{ξ}=ξ−\hat{ξ}.

### Notations

| Notation | Description |
|---|---|
| λₛ | stator flux vector |
| λᵣ | rotor flux vector |
| iₛ | stator current vector |
| iᵣ | rotor current vector |
| uₛ | stator voltage vector |
| λ_{ds}, λ_{qs} | stator fluxes in d- and q-axis |
| λ_{dr}, λ_{qr} | rotor fluxes in d- and q-axis |
| i_{ds}, i_{qs} | stator currents in d- and q-axis |
| u_{ds}, u_{qs} | stator voltages in d- and q-axis |
| ω₀ | angular speed of a rotating frame |
| ωₛ | synchronous stator electrical speed |
| ωᵣ | rotor electrical angular speed |
| ωₛₗᵢₚ | slip angular speed |
| ρ | rotor flux field angle |
| θ | angle of a rotating frame |
| Tₑ | electric torque |
| Tₗ | load torque |
| T* | torque reference |

${i}_{ds}^{*} , {i}_{qs}^{*} references of stator currents in d - and q - axis$

| | |
|---|---|
| p | number of pole pairs |
| Rₛ, Rᵣ | stator and rotor resistances |
| Lₛ, Lₘ, Lᵣ | stator, mutual, and rotor inductances |

$σ leakage factor , \frac{{L}_{s} {L}_{r} - {L}_{m}^{2}}{{L}_{s} {L}_{r}}$

| | |
|---|---|
| α | Rᵣ/Lᵣ |
| β | Lₘ/Lᵣ × 1/(Lₛσ) |
| γ | Rₛ/(Lₛσ) + αβLₘ |
| J | rotor inertia |

### Motion Control System

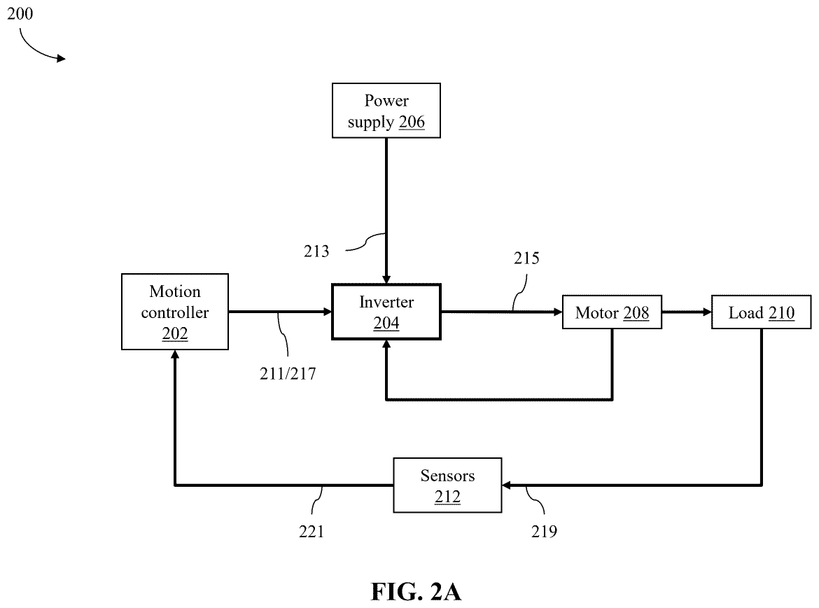

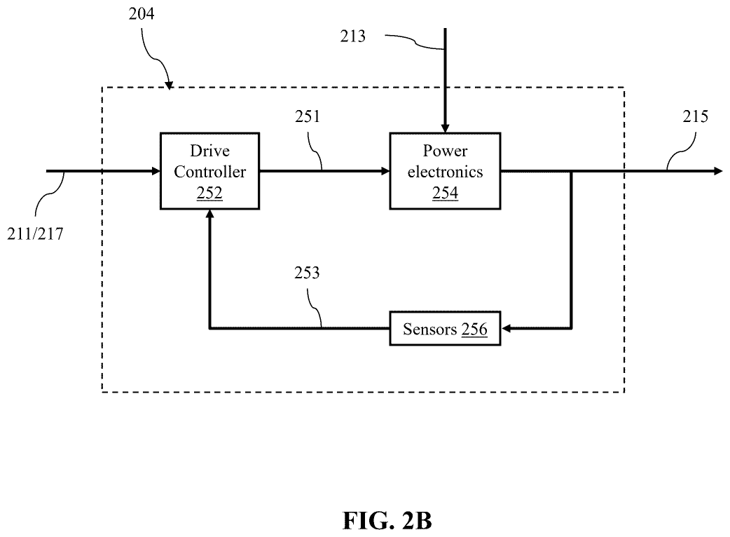

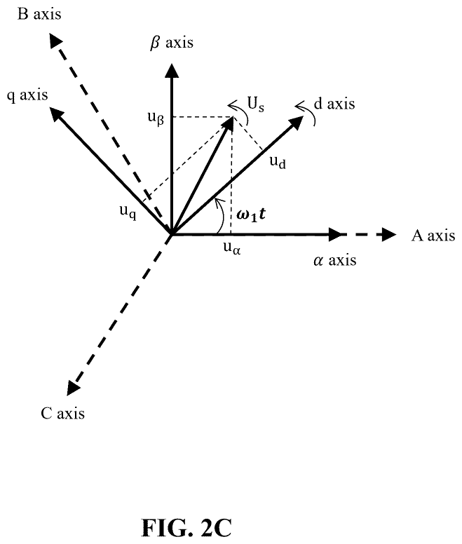

FIG. 2A illustrates a block diagram of a motion control system 200, according to some embodiments. The motion control system 200 is configured to control an electric motor 208, which serves as a torque actuator to drive a load 210, in accordance with some embodiments of the disclosure. The system 200 is designed to provide precise control over the motor torque and speed by leveraging both a motion controller 202 and an inverter 204, enabling smooth operation across a range of speeds, including near zero speed.

In this embodiment, the motion controller 202 receives input commands and computes reference values for the torque and speed of the motor 208. Specifically, the motion controller 202 generates a torque reference signal 211 and a speed reference 217, where each reference signal may define a target torque that the motor 208 should produce, while the speed reference signal 217 specifies a desired rotor speed. The reference is computed based on the requirement of the application and the load 210 being driven.

The inverter 204, connected to the power supply 206, is responsible for converting DC power 213 into controlled AC voltages 215, which are then applied to the motor 208. The inverter 204 operates according to the reference torque 211 by modulating the output voltage 215 to generate the specified torque in the motor 208. Similarly, if the reference speed 217 is supplied, the inverter 204 adjusts the voltage 215 to drive the motor 208 at the specified speed.

The motor 208 receives these voltages 215, which results in electromagnetic forces that produce a corresponding torque. This torque causes the motor rotor to rotate, driving the load 210 attached to the motor shaft. The load 210 may represent any mechanical system requiring controlled torque or speed, such as an industrial machine, conveyor system, or vehicle drivetrain. The system 200 configuration allows the motion controller 202 to dynamically adjust the torque or speed of the motor 208 based on real time feedback.

FIG. 2B illustrates a schematic of the inverter 204, which serves as a central component in controlling an electric motor by managing the supply of electrical power on reference settings. The inverter 204 comprises a drive controller 252, power electronics 254, and embedded sensor 256, each of which plays a role in achieving precise and dynamic control of motor operation.

The drive controller 252 acts as the core control unit, implemented on a microcontroller. The controller operates based on a programmed control algorithm designed to handle dynamic adjustment in the motor control. Specifically, the driver controller 252 receives sensor signal as feedback on motor 208 operation, as well as control reference 211 and 217 which corresponds to the desired torque or speed of the motor. Based on this information, the drive controller 252 determines the reference 251 for voltage 215 to be applied by the power electronics 254. These voltage references ensure that the motor operates according to the specified torque or speed in real time.

The power electronics 254, commonly referred to as voltage source inverter (VSI), is responsible for converting the voltage reference 251 into actual voltage output 215 that power the motor 208. For a three phase AC motor, the power electronics 254 generate three separate voltage signals, each corresponding to one of the three stator windings, labelled phase A, phase B, phase C. These voltages are phase shifted by a fixed angle of 120 degree relative to one another, as shown in FIG. 2C, which is necessary to create a balanced three phase AC signal. This balanced output facilitates the generation of a rotating magnetic field within the motor, which in turn drives the motor rotor.

The inverter 204 includes the sensor 256 that monitors the three phase currents flowing through each stator winding. These sensors feed real time data back to the drive controller 252, allowing with the reference signal. This feedback loop is critical to maintaining motor stability and achieving the desired performance.

The system operates over a full range of speed and torque levels, including low or zero speed and near zero frequencies, allowing the motor to function effectively even under challenging conditions. This capability is essential for application requiring stable control at very low speed or when the motor 208 is desired to be operated near zero frequency.

FIG. 2C illustrates three frames used for motor control of induction machines. The A-B-C frame is formed by three axes A, B and C, where each axis is 120° degree apart from the other. The A axis is always in alignment with the angle of phase A voltage of the motor. A dq frame, defined by two orthogonal axes d and q axes, rotates at an angular speed of ω₀ which equals the angular speed ωₛ of the rotor flux vector. Particularly, the d-axis of the dq frame always aligns with the rotor flux vector λᵣ. An αβ frame is when Ω₀=0, which is also called stationary (or stator) frame. The stationary frame is denoted as αβ frame in FIG. 2. The three frames can be transformed to each other via Clarke/Park Transformations or their inverse. Specifically, applying Clarke transformation on the A-B-C frame gives the stationary frame, where applying the Park transformation on the stationary frame gives the dq frame. The Clarke transformation is a mathematical transformation employed to transform quantities in a three-phase, corresponding to A, B, and C axes in FIG. 2C, to a two-phase system, corresponding to α, β axes. Representing quantities in a space vector form significantly simplifies the analysis of three-phase systems. In this disclosure, Clarke transformation is limited to the case which transforms quantities in three-phase such as three-phase stator voltages and currents into a space vector in the stationary frame. Similarly, the Park transformation, or known as d-q transformation, projects the quantities in a stationary frame onto a rotating frame. Clarke/Park transformation and its inverse are well-known for those skilled in the art, and their rigorous description is omitted.

Also, some embodiments disclose a control method of operating motor at over its full range of speeds and torque region, including zero/near zero frequency or at zero/near zero speed. For illustration purpose, the motor is considered as a type of induction machine. The method can be extended to permanent magnet synchronous machine for those skilled in the art.

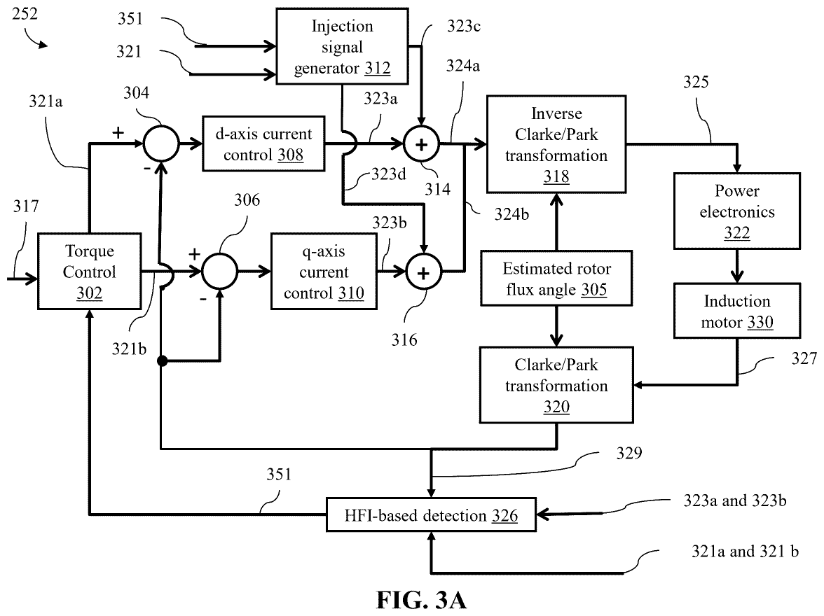

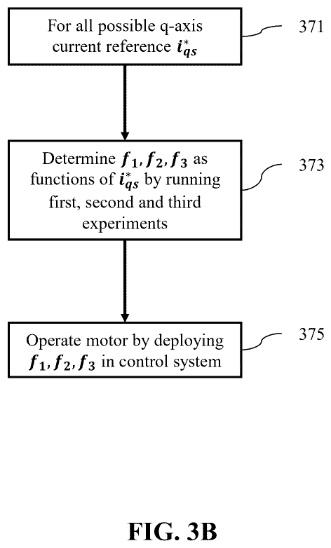

FIG. 3A illustrates schematics of the drive controller 252 for operating an induction machine such as the motor 330 at torque control mode, according to some embodiments. In the torque control mode, the reference 317 of the drive controller 252 is the temporal profile of the preferred torque, denoted as T*. The torque control module 302 determines d-axis current reference

$${i}_{ds}^{*}$$

321a and q-axis current reference

$${i}_{q s}^{*}$$

321b according to the estimated rotor flux angle \hat{θ} 305, an estimated rotor speed \hat{ω}ᵣ, and an estimated synchronous speed (or synchronous frequency) \hat{ω}ₛ which are outputted from an HFI-based detection module 326. An injection signal generator 312 outputs a q-axis pre-injection voltage signal 323c based on the estimated synchronous speed \hat{ω}ₛ provided by the HFI based detection module 326. This signal 323c assists in accurately controlling the induction machine, particularly at lower speed or near zero frequency condition. The input to the injection signal generator 312 is q-axis reference current 321a, d-axis reference current 321b and HFI feedback 351.

For precise torque control, the drive controller 252 utilizes the comparator 304 to compare the d-axis current reference

$${i}_{ds}^{*}$$

321a with the actual d-axis current i_{ds}, measured from the motor 330. The resulting error signal is then supplied to the d-axis current control block 308, which generates a d-axis reference voltage u_{ds} 323a. An injection signal

$${u}_{ds}^{h}$$

is added to this generated d-axis reference voltage u_{ds} 323a in the adder 314 to produce the d-axis reference voltage

$${u}_{ds}^{*}$$

324a.

Similarly, the q-axis current reference

$${i}_{q s}^{*}$$

321b is added in the adder 316 with the measured q-axis current i_{qs}, and the difference is processed by the q-axis current control block 310 to produce the q-axis reference voltage

$${u}_{q s}^{*}$$

324b.

The controller 252 converts these d-axis and q-axis reference voltages

$${u}_{ds}^{*} and {u}_{qs}^{*}$$

(i.e., 324a and 324b) into a three-phase voltage reference u=[uₐ, u_{b}, u_{c}]^{T} 325 through an inverse Clarke/Park transformation 318. The three phase voltage reference 325 is forwarded to the power electronics section 322, which generates the actual three phase voltages to power the induction motor 330.

Since the induction motor 330 operates without direct position or speed sensor, the HFI based detection 326 is employed to provide real time estimates of the rotor flux angle and its frequency (synchronous speed) based on the measurement of three phase currents of the motor. The three phase currents are transformed by Clarke/Park transformation 320 (fully determined by the estimated rotor flux angle which defines the estimate rotor flux reference frame) into measured d- and q-axis current 329 before feeding into the HFI-based detection module 326.

FIG. 3B illustrates a procedure for commissioning the control method described in FIG. 3A, according to some embodiments the procedure involves series of steps to initialize and optimize the control system for operating an induction machine in torque control mode.

In some embodiments, the d-axis reference current

$${i}_{ds}^{*}$$

is pre-selected as its rated current value. This ensures that the rotor flux is appropriately established during the commissioning process. A range of q-axis reference current value

$${i}_{qs}^{*}$$

is defined 371, spanning from the negative rated value to the positive rated value. These values cover the full operational range of the motor under torque.

For each selected q-axis reference current

$${i}_{qs}^{*} ,$$

three distinct standstill experiments are performed 373. The first experiment is conducted with the motor at a standstill to evaluate the system response to be selected

$${i}_{qs}^{*} .$$

Data Collected during this experiment is used to determine the function

$${f}_{1} ( {i}_{qs}^{*} ) ,$$

which represent the tilted angle as a function of

$$( {i}_{qs}^{*} )$$

-a specific performance characteristic of the motor under different load conditions.

The second experiment, also performed with the motor at a standstill, further analyses the system response for the same

$${i}_{qs}^{*} .$$

This experiment determines the offset to be canceled as

$${f}_{2} ( {i}_{qs}^{*} )$$

as a function of

$${i}_{qs}^{*} ,$$

capturing another aspect of the motor performance. In the third experiment 373, additional system behavior is recorded for the same

$${i}_{qs}^{*} ,$$

providing data to derive

$${f}_{3} ( {i}_{qs}^{*} ) ,$$

which represents the optimal slope as a function of

$${i}_{qs}^{*} .$$

The outcome of the first, second and third standstill experiment are used to formulate the function

$${f}_{1} ( {i}_{qs}^{*} ) , {f}_{2} ( {i}_{qs}^{*} ) and {f}_{3} ( {i}_{qs}^{*} ) ,$$

which describes specific characteristics of the motor operation under varying q-axis current reference.

After determining the functional relationships, the motor is operated according to the control system described in FIG. 3A. The functions

$${f}_{1} ( {i}_{qs}^{*} ) , {f}_{2} ( {i}_{qs}^{*} ) and {f}_{3} ( {i}_{qs}^{*} )$$

are utilized to determine the control parameters (tilted angle, offset and slope in the error signal), enabling precise torque across the motor operating range 375.

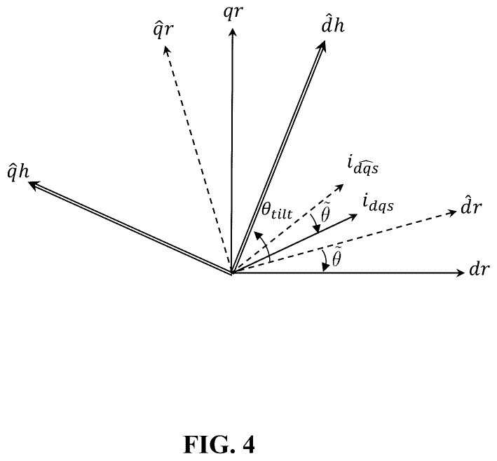

FIG. 4 illustrates the additional reference frames utilized in the HFI based detection method. These frames are essential for accurately estimating the rotor flux and improving the precision of the control system, for induction machine.

The true dq frame is uniquely parameterized by the true rotor flux angle and comprises two orthogonal axes. The dr-axis, which aligns with the direction of the motor flux and the qr axis, which is orthogonal to the \hat{d}r axis and the \hat{q}r axis. The estimated dq frame, denoted as dq, is uniquely parameterized by the estimated rotor flux angle. It is composed of d-axis, which aligns with the estimated rotor flux direction, and the q-axis, which is orthogonal to the d-axis. The error between the true dq frame and the estimated dq frame is quantified by the angle difference \tilde{θ}, defined as \tilde{θ}=θ−\hat{θ}. This error angle represents the discrepancy between the true and estimated rotor flux angles and minimizing \tilde{θ} is critical for accurate motor control.

The tilted dq frame, denoted as [symbol] , is uniquely parameterized by the titled rotor flux angle. The angle difference between the estimated dq frame and the tilted dq frame is denoted as θₜᵢₗₜ=\hat{θ}ₕ−\hat{θ}. This tilted frame is introduced to enhance the robustness of the rotor flux angle estimation under varying operating conditions by aligning more closely with the rotor flux orientation.

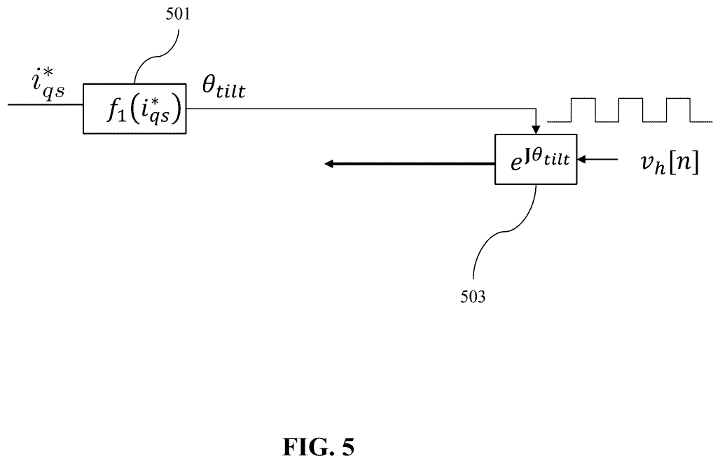

FIG. 5 illustrates an embodiment of the signal generation module employed in the HFI based detection method. This module generates voltage signals essential for accurately estimating rotor flux angle and enhancing the performance of the control system for an induction machine.

The signal generation process begins with the q-axis reference current

$${i}_{qs}^{*}$$

as an input a tilt angle θₜᵢₗₜ is determined based on a predefined function 501, denoted as

$$f ( {i}_{qs}^{*} ) .$$

This tilt angle serves as a critical parameter for generation voltage signal in the tilted dq frame. Using the determined tilt angle θₜᵢₗₜ, a rotation matrix e^{Jθ}^{ₜᵢₗₜ} is constructed which rotates a voltage vector [symbol] = [symbol] in the tilted frame [symbol] to its counterpart in the [symbol] frame. Here [symbol] is a square voltage and [symbol] has zero voltage along the q-axis of the [symbol] frame. This matrix enables the transformation of voltage vectors from the tilted frame [symbol] to the standard dq frame. The rotation matrix aligns the voltage signals for accurate signal injection and control.

The tilted frame, a voltage vector [symbol] is defined as [symbol] = [symbol] , [symbol] is the square wave voltage magnitude injected along the [symbol] axis, the [symbol] axis voltage component is zero.

The high-frequency square-wave voltage signal is injected along the [symbol] axis of the tilted frame according to the following formula

$$= [ \begin{matrix}{V}_{h} \\ 0\end{matrix} ] \cdot {( - 1 )}^{n} , n = 0 , 1 , 2 , \qquad ( 1 )$$

where Vₕ is the magnitude of voltage injection, and n is the number of sampling period. The injection signal in the [symbol] frame is given

$${u}_{h} = {e}^{J {θ}_{tilt}} = {[ {u}_{ds}^{h} , {u}_{qs}^{h} ]}^{T} ,$$

i.e., the q-axis pre-injection voltage signal and d-axis pre-injection voltage signal are defined. Using the rotation matrix e^{Jθ}^{ₜᵢₗₜ} 503, the tilted frame [symbol] is transformed into its counterpart in the standard [symbol] frame. The resulting voltage signals in the [symbol] frame is denoted as

$${u}_{h} = {e}^{J {θ}_{tilt}} = {[ {u}_{ds}^{h} , {u}_{qs}^{h} ]}^{T} ,$$

i.e., the q-axis pre-injection voltage signal and d-axis pre-injection voltage signal are defined.

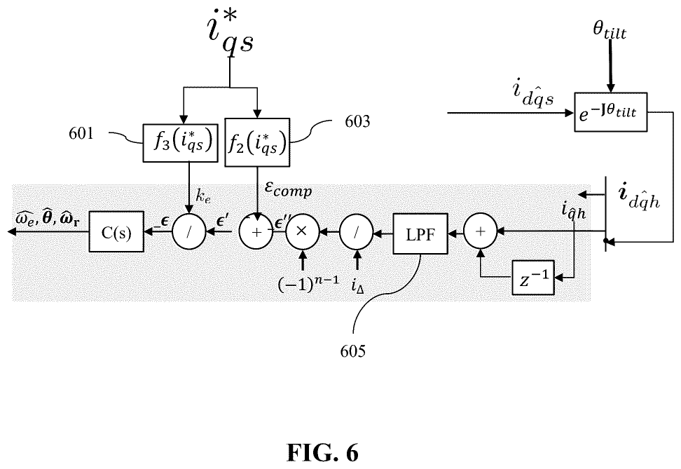

FIG. 6 illustrates an embodiment of the HFI based detection module used to estimate critical parameters such as rotor flux angle, synchronous speed and rotor speed in compensation to ensure robust and accurate detection. The measured current in the [symbol] frame, denoted as [symbol] through the application of a rotation transformation. This transformation aligns the measured currents with the tilted frame, where

$$= [ {i}_{ds ,}^{*} {i}_{qs}^{*} ] .$$

The [symbol] -axis component of the measured current [symbol] is processed to generate an initial error signal ϵ″. This error signal represents the deviation between the actual and estimated parameters and serves as a key input for the detection process.

The primary error signal ϵ″ is compensated using two predefined functions 601

$${f}_{3} ( {i}_{qs}^{*} )$$

and 603

$${f}_{2} ( {i}_{qs}^{*} ) ,$$

which are functions of the q-axis reference current

$${i}_{qs}^{*} .$$

The compensated error signal ϵ″. The compensated error signal ϵ″ is passed through a low-pass filter 605 to mitigate high-frequency noise. The filter is designed to remove noise frequency significantly higher than the injected voltage signal frequency. The filtered signal is the then utilized to estimate synchronous speed, rotor flux angle and rotor speed. These estimated are fed back into the control system to enhance the accuracy and robustness of torque and speed control.

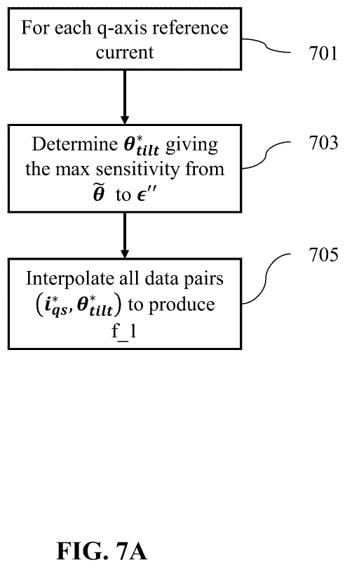

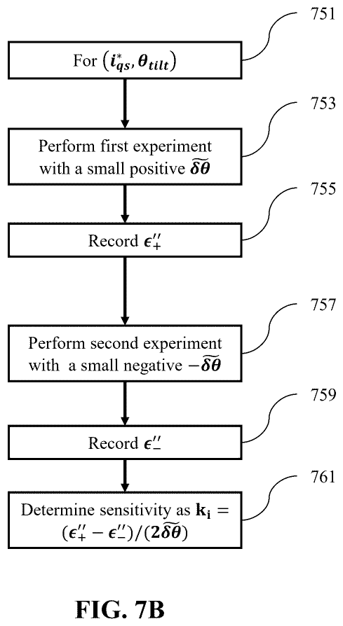

FIG. 7A discloses a method to determine 701

$${f}_{1} ( {i}_{qs}^{*} ) ,$$

a function of q-axis reference current

$${i}_{qs}^{*} ,$$

or equivalently the torque reference T*. This function plays a critical role in determining 703 the tilt angle

$${θ}_{tilt}^{*}$$

to optimize sensitivity and maintain stability. The tilt angle

$${θ}_{tilt}^{*}$$

is adjusted to determine the value that provides the maximum sensitivity between the tilt angle

$${θ}_{tilt}^{*}$$

and the error signal ϵ″. The tilt angle must also maintain a consistent sign of sensitivity across the entire range of

$${i}_{qs}^{*}$$

ensuring stability in the control system.

The optimal tilt angle

$${θ}_{tilt}^{*}$$

obtained ror various q-axis reference current

$${i}_{qs}^{*}$$

are recorded as data pairs

$$( {i}_{qs}^{*} , {θ}_{tilt}^{*} ) .$$

These pairs are used to formulate

$${f}_{1} ( {i}_{qs}^{*} )$$

as an interpolation function 705, enabling smooth and continuous computation of the tilt angle for any given obtain

$${i}_{qs}^{*} .$$

FIG. 7B discloses a method for calculating the sensitivity (slope) of the error signal ϵ″ with respect to the rotor flux angle error \tilde{θ} for a given 751 q-axis reference current

$${i}_{qs}^{*}$$

and a specified tilt angle θₜᵢₗₜ. The sensitivity is a critical parameter for calibrating the control system for accurate motor operation. 753 The motor is operated at standstill using the drive controller 252 illustrated in FIG. 3A. The rotor flux angle error \tilde{θ} is deliberately controlled to a known positive amplitude+ [symbol] The corresponding error signal ϵ″₊ is recorded 755.

The motor is again operated at standstill 757 using the drive controller 252 of FIG. 3A. The rotor flux angle error \tilde{θ} is deliberately controlled to a known negative amplitude− [symbol] . The corresponding error signal ϵ″₋ is recorded 759. For the given

$${i}_{qs}^{*}$$

and θₜᵢₗₜ, the sensitivity

$${k}_{i} ( {i}_{qs}^{*} , {θ}_{tilt} )$$

is determined 761 as

$${k}_{i} ( {i}_{qs}^{*} , {θ}_{tilt} ) = \frac{{ϵ}_{+}^{″} - {ϵ}_{-}^{″}}{2}$$

This sensitivity measures the response of the error signal to changes in the rotor flux angle error, enabling precise calibration of the control system.

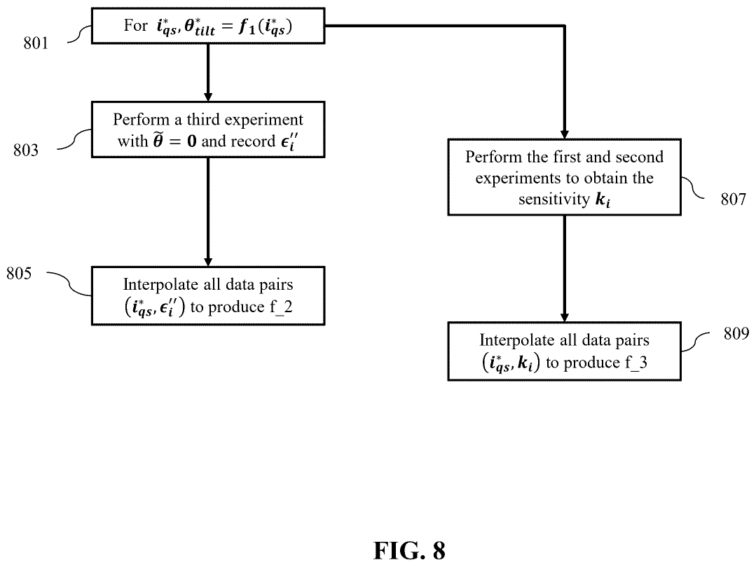

FIG. 8 illustrates a method to determine the function

$${f}_{2} ( {i}_{qs}^{*} ) and {f}_{3} ( {i}_{qs}^{*} ) ,$$

which are function of the q-axis reference current

$${i}_{qs}^{*}$$

and use to compensate for error in the control system. 801 For a given

$${i}_{qs}^{*}$$

and the corresponding optimal tilt angle

$${θ}_{tilt}^{*} .$$

A third standstill experiment is performed 803 by operating the motor using the drive controller 252 shown in FIG. 3A. The process is repeated for all

$${i}_{qs}^{*}$$

values across the desired range. The function

$${f}_{2} ( {i}_{qs}^{*} )$$

is desired by 805 interpolating the recorded pairs of data

$$( {i}_{qs}^{*} , {ϵ}_{i}^{″} ) .$$

For the optimal tilt angle

$${θ}_{tilt}^{*}$$

corresponding to each

$${i}_{qs}^{*} ,$$

the sensitivity

$${k}_{i} ( {i}_{qs}^{*} , {θ}_{tilt} )$$

is determined. 807 The first and second standstill experiments as described in FIG. 7B to calculate

$${k}_{i} ( {i}_{qs}^{*} , {θ}_{t i l t} ) .$$

The pairs of the data are recorded

$$( {i}_{qs}^{*} , {k}_{i} ) .$$

The function

$${f}_{3} ( {i}_{q s}^{*} )$$

is obtained by interpolating 809 the recorded data pairs

$$( {i}_{qs}^{*} , {k}_{i} ) .$$

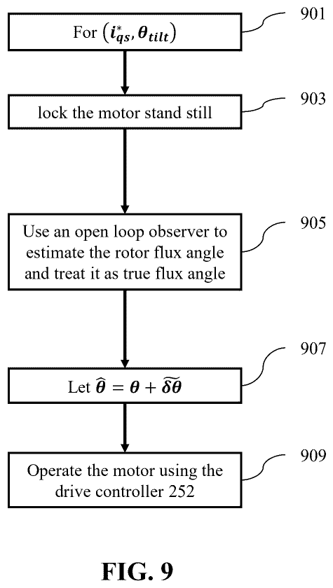

FIG. 9 illustrates an embodiment of performing first stand-still experiment. 901 For a give pair of

$$( {i}_{qs}^{*} , {θ}_{tilt} ) ,$$

we lock the motor so that it does not rotation (stand still) 903. Then, we use an open loop flux observer to estimate the rotor flux angle and treat it as the true flux angle, i.e., θ is known 905. During first experiment, we let the estimate flux angle, used in Clarke/Park transformations as well as their inverse, 907 be \hat{θ}=θ+ [symbol] , and 909 operate the motor accord to FIG. 3A. Second stand still experiment follows the same procedure except that the motor is operated with the estimate rotor flux angle being \hat{θ}=θ− [symbol] . Third stand still experiment follows the same procedure except that the motor is operated with the estimate rotor flux angle being \hat{θ}=θ.

Open-loop flux observer for induction machine is known for those skilled in the art and thus its description is omitted in this disclosure.

In some embodiments,

$${i}_{ds}^{*}$$

can be determined as the value which maximizes the sensitivity from \tilde{θ} to the error signal ϵ″ by performing first and second experiments.

In some embodiments, the second signal ϵ is fed into the following speed estimator operates according to the following equations:

$${\hat{ω}}_{r} = ( {K}_{p} + \frac{{K}_{i}}{s} ) LP ( s ) ϵ \qquad ( 2 )$$

$${\hat{ω}}_{s} = {\hat{ω}}_{r} + \frac{α {L}_{m} {i}_{q s}}{{λ}_{dr}^{⋆}} ,$$

where s is Laplace transformation operator,

$${K}_{p} = 2 {ξω}_{bw} , {K}_{i} = {ω}_{bw}^{2} , ξ ∈ ( 0 , 1 ]$$

is the damping ratio, ω_{bw} is the closed loop bandwidth and LP(s) is the lead compensator admitting the following transfer function

$$L P ( s ) = \frac{{α}_{c} τ s + 1}{τ s + 1} ,$$

where τ>0 is the time constant and α_{c}>1.

In another embodiments, the second signal ϵ is fed into the following speed estimator operates according to the following equations:

$${\hat{ω}}_{r} = ( {K}_{p} + \frac{{K}_{i}}{s} ) ϵ \qquad ( 3 )$$

$${ω}_{s} = {\hat{ω}}_{r} + \frac{α {L}_{m} {i}_{q s}}{{λ}_{dr}^{⋆}} .$$

In another embodiments, the second signal ϵ is fed into the following speed estimator operates according to the following equations:

$${\hat{ω}}_{s} = ( {K}_{p} + \frac{{K}_{i}}{s} ) ϵ \qquad ( 4 )$$

$${ω}_{r} = {\hat{ω}}_{s} - \frac{α {L}_{m} {i}_{q s}}{{λ}_{dr}^{⋆}} .$$

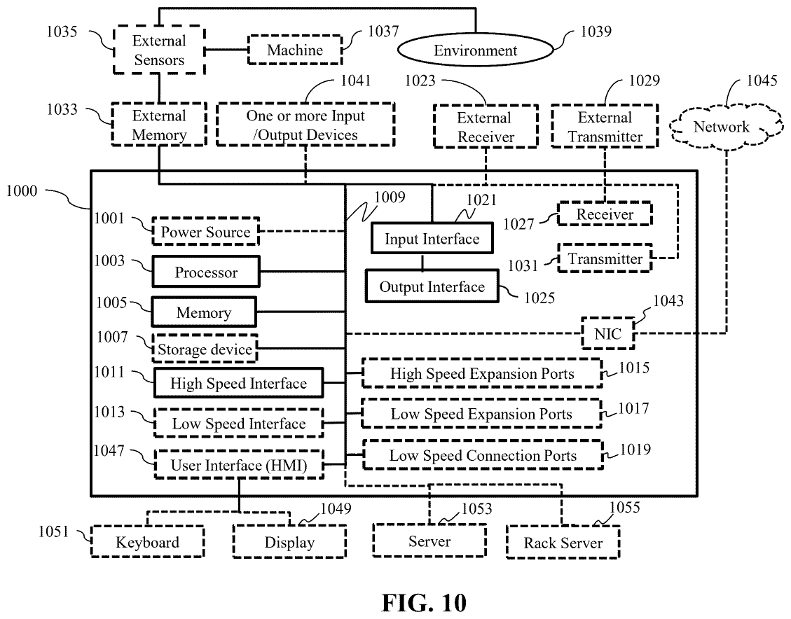

FIG. 10 shows a schematic diagram of some components of a control system 1000 for controlling a motor, in accordance with some embodiments of the present disclosure. The control system 1000 includes a power source 1001, a processor 1003, a memory 1005, a storage device 1007, all connected to a bus 1009. Further, a high-speed interface 1011, a low-speed interface 1013, high-speed expansion ports 1015 and low speed connection ports 1017, can be connected to the bus 1009. In addition, a low-speed expansion port 1019 is in connection with the bus 1009. Further, an input interface 1021 can be connected via the bus 1009 to an external receiver 1023 and an output interface 1025. A receiver 1027 can be connected to an external transmitter 1029 and a transmitter 1031 via the bus 1009. Also connected to the bus 1009 can be an external memory 1033, external sensors 1035, machine(s) 1037, and an environment 1039. Further, one or more external input/output devices 1041 can be connected to the bus 1009. A network interface controller (NIC) 1043 can be adapted to connect through the bus 1009 to a network 1045, wherein data or other data, among other things, can be rendered on a third-party display device, third party imaging device, and/or third-party printing device outside of the control system 1000.

The memory 1005 may store instructions that are executable by the control system 1000 and any data that can be utilized by the methods and systems of the present disclosure. The memory 1005 can include random access memory (RAM), read only memory (ROM), flash memory, or any other suitable memory systems. The memory 1005 can be a volatile memory unit or units, and/or a non-volatile memory unit or units. The memory 1005 may also be another form of computer-readable medium, such as a magnetic or optical disk.

The storage device 1007 can be adapted to store supplementary data and/or software modules used by the control system 1000. The storage device 1007 can include a hard drive, an optical drive, a thumb-drive, an array of drives, or any combinations thereof. Further, the storage device 1007 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 1003), perform one or more methods, such as those described above.

The control system 1000 can be linked through the bus 1009, optionally, to a display interface or user Interface (HMI) 1047 adapted to connect the system 1000 to a display device 1049 and a keyboard 1051, wherein the display device 1049 can include a computer monitor, camera, television, projector, or mobile device, among others. In some implementations, the system 1000 may include a printer interface to connect to a printing device, wherein the printing device can include a liquid inkjet printer, solid ink printer, large-scale commercial printer, thermal printer, UV printer, or dye-sublimation printer, among others.

The high-speed interface 1011 manages bandwidth-intensive operations for the control system 1000, while the low-speed interface 1013 manages lower bandwidth-intensive operations. Such allocation of functions is an example only. In some implementations, the high-speed interface 1011 can be coupled to the memory 1005, the user interface such as a Human Machine Interface (HMI) 1047, and to the keyboard 1051 and the display 1049 (e.g., through a graphics processor or accelerator), and to the high-speed expansion ports 1015, which may accept various expansion cards via the bus 1009. In an implementation, the low-speed interface 1013 is coupled to the storage device 1007 and the low-speed expansion ports 1017, via the bus 1009. The low-speed expansion ports 1017, which may include various communication ports (e.g., USB, Bluetooth, Ethernet, wireless Ethernet) may be coupled to the one or more input/output devices 1041. The control system 1000 may be connected to a server 1053 and a rack server 1055. The control system 1000 may be implemented in several different forms. For example, the control system 1000 may be implemented as part of the rack server 1055.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A method for controlling an operation of an induction motor across varying operational conditions, including near-zero frequency, the method comprising:
collecting a reference value of d-axis current of the induction motor, a reference value of q-axis current of the induction motor, and a torque control error signal for the induction motor;
operating the induction motor in accordance with the reference value of d-axis current and the reference value of q-axis current;
measuring real-time amplitudes of the d-axis current and the q-axis current in an estimated rotor flux reference frame during the operation of the induction motor, wherein an estimated rotor flux reference frame angle represents a position of the estimated rotor flux frame;
calculating a tilted angle relative to the estimated rotor flux reference frame for the induction motor, based on the real-time amplitudes of d-axis current and q-axis current, wherein the tilted angle is determined offline to maximize a slope gain from an error between the estimated rotor flux reference frame angle and a true rotor flux reference frame angle to the torque control error signal while maintaining a consistent sign of the slope gain across the varying operating conditions;
injecting a high-frequency signal into the induction motor at the calculated tilted angle relative to the estimated rotor flux reference frame;
applying an offset correction to the torque control error signal, based on the calculated tilted angle, the measured d-axis current amplitude, and the measured q-axis current amplitude to compensate for inaccuracies arising from the high-frequency signal injection; and
adjusting the tilted angle continuously in response to changing operational conditions.

2. The method of claim 1, wherein the tilted angle is determined offline as a function of a d-axis current reference and a q-axis current reference of the induction motor, wherein the offset is determined offline as a function of the d-axis current reference and the q-axis current reference, and wherein the slope is determined offline as a function of the d-axis current reference and the q-axis current reference.

3. The method of claim 1, wherein the tilted angle is determined offline as a function of a q-axis current reference, wherein the offset is determined offline as a function of the q-axis current reference, and wherein the slope is determined offline as a function of the q-axis current reference.

4. The method of claim 1, wherein the tilted angle is determined offline as a function of a torque reference, wherein the offset is determined offline as a function of the torque reference, and wherein the slope is determined offline as a function of the torque reference.

5. The method of claim 1, further comprising applying the offset correction using interpolation functions derived from calibration experiments, based on recorded data pairs of q-axis reference current.

6. The method of claim 1, wherein the real-time amplitudes of the d-axis current and the q-axis current in the estimated rotor flux frame are generated from measured three-phase currents of the induction motor using Clarke and Park transformations.

7. The method of claim 1, further comprising dynamically adjusting a magnitude of the high frequency signal, the tilted angle, the slope, and parameters of the offset correction based on real-time torque control requirements to continuously adapt the motor for near-zero frequencies.

8. The method of claim 1, wherein the high frequency injection signal is a square wave with a frequency equal to half of a pulse width modulation frequency associated with the induction motor.

9. The method of claim 1, wherein the torque control error signal is obtained by
processing the q-axis current with a band pass filter to obtain a high frequency component;
determining the amplitude of a first error signal by demodulating the high frequency component;
applying the offset correction to obtain a second error signal by removing offset from the first error signal;
obtaining a third error signal by applying scaling to the second error signal; and
processing the third error signal to produce an estimate of rotor flux angle, rotor flux frequency, and rotor speed of the induction motor.

10. The method of claim 9, wherein the processing the third error signal comprises:
feeding through the third error signal into a lead compensator; and
applying phase lock loop on an output of the lead compensator to produce an estimate of the rotor speed.

11. A system for controlling an induction motor across varying operational conditions, including near-zero frequency, the system comprising:
circuitry configured to:
inject a high frequency injection (HFI) signal into the induction motor at an adjustable tilted angle relative to an estimated rotor flux reference frame;
measure real-time amplitude of d-axis current and real-time amplitude of q-axis current during the operation of the induction motor;
dynamically determine the tilted angle based on the real-time amplitude of d-axis current and real-time amplitude of q-axis current, wherein the tilted angle is determined offline to maximize a slope gain from an error between the estimated rotor flux reference frame angle and a true rotor flux reference frame angle to a torque control error signal for the induction motor, while maintaining a consistent sign of the slop gain across varying operational conditions;
apply an offset correction to the torque control error signal based on the determined tilted angle, the measured real-time amplitude of d-axis current and real-time amplitude of q-axis current to compensate for inaccuracies from the HFI signal; and
continuously adjust the tilted angle in response to changing operational conditions of the induction motor.

12. The system of claim 11, wherein the circuitry is configured to determine the tilted angle to maintain sensitivity of the torque control error signal over a full range of operating conditions, including variations in q-axis reference current.

13. The system of claim 11, wherein the circuitry is configured to apply the offset correction using interpolation functions derived from calibration experiments, based on recorded data pairs of q-axis reference current.

14. The system of claim 11, wherein the circuitry produces the real-time amplitude of d-axis current and real-time amplitude of q-axis current from a measured three-phase currents using Clarke and Park transformations.

15. The system of claim 11, wherein the circuitry is configured to continuously adapt the system for near-zero frequencies by dynamically adjusting the high frequency signal magnitude and offset correction parameters based on real-time torque control requirements.

16. The system of claim 11, wherein the circuitry comprises a tilted angle measurement module and an offset correction module configured to operate in a feedback loop to continuously optimize the motor operation by reducing errors caused by parameter inaccuracies.
